(19) United States
(12) Patent Application Publication
(10) Pub. No.: US 2016/0381728 A1
(43) Pub. Date: Dec. 29, 2016

(54) WIRELESS ACCESS MANAGEMENT TECHNIQUES FOR WIRELESSLY-ACCESSIBLE DEVICES

(71) Applicants: Daniel COHN, Raanana (IL); Michael GLIK, Kfar Saba (IL); Elad LEVY, Nes Ziona (IL); Solomon TRAININ, Haifa (IL); Adam ELMAN, Sunnyvale, CA (US)

(72) Inventors: Daniel COHN, Raanana (IL); Michael GLIK, Kfar Saba (IL); Elad LEVY, Nes Ziona (IL); Solomon TRAININ, Haifa (IL); Adam ELMAN, Sunnyvale, CA (US)

(21) Appl. No.: 14/752,704

(22) Filed: Jun. 26, 2015

(51) Int. Cl. H04W 76/02; H04W 48/02; H04W 8/00

(52) U.S. Cl. CPC H04W 76/023; H04W 8/005; H04W 48/02

(57) ABSTRACT

Wireless access management techniques for wirelessly-accessible devices are described. In one embodiment, for example, at least one non-transitory computer-readable storage medium may comprise a set of instructions that, in response to being executed on a computing device, cause the computing device to identify a connection request of a mobile client based on a received connection establishment message, determine whether the connection request comprises an automatic connection request based on request attribute information contained in the connection establishment message, and in response to a determination that the connection request comprises an automatic connection request, generate a prompt for a confirmation that the connection request is to be granted. Other embodiments are described and claimed.

### TECHNICAL FIELD

Embodiments described herein generally relate to wireless communications between devices in wireless networks and/or wireless peer-to-peer communications.

### BACKGROUND

In order to wirelessly access and use peripherals and/or other devices, a mobile client may establish wireless connectivity to those peripherals and/or other devices via an intermediate node. For example, a mobile client may wirelessly access and use a monitor, keyboard, and mouse by establishing wireless connectivity to the monitor, keyboard, and mouse via a wireless docking station. In some cases, a mobile client may request wireless access to a set of peripherals and/or other devices in response to an explicit instruction input by a user. In other cases, a mobile client may request such wireless access automatically. For example, a given mobile client may be configured to automatically request access to a previously-used wireless docking station upon subsequently entering wireless communication range of that wireless docking station. Some peripherals and/or other devices may be capable of being used by only one mobile client and/or associated user at a time. If such a peripheral or other device is already in use at the time that a mobile client requests access to it, then granting the requested access to the mobile client may require revoking access from the existing user.

### BRIEF DESCRIPTION OF THE DRAWINGS

FIG. 1 illustrates an embodiment of a first operating environment.

FIG. 2 illustrates an embodiment of a second operating environment.

FIG. 3 illustrates an embodiment of an information element.

FIG. 4 illustrates an embodiment of a first logic flow.

FIG. 5 illustrates an embodiment of a second logic flow.

FIG. 6 illustrates an embodiment of a first operational flow.

FIG. 7 illustrates an embodiment of a second operational flow.

FIG. 8 illustrates an embodiment of a storage medium.

FIG. 9 illustrates an embodiment of a device.

FIG. 10 illustrates an embodiment of a wireless network.

### DETAILED DESCRIPTION

Various embodiments may be generally directed to wireless access management techniques for wirelessly-accessible devices. In one embodiment, for example, at least one non-transitory computer-readable storage medium may comprise a set of instructions that, in response to being executed on a computing device, cause the computing device to identify a connection request of a mobile client based on a received connection establishment message, determine whether the connection request comprises an automatic connection request based on request attribute information contained in the connection establishment message, and in response to a determination that the connection request comprises an automatic connection request, generate a prompt for a confirmation that the connection request is to be granted. Other embodiments are described and claimed.

Various embodiments may comprise one or more elements. An element may comprise any structure arranged to perform certain operations. Each element may be implemented as hardware, software, or any combination thereof, as desired for a given set of design parameters or performance constraints. Although an embodiment may be described with a limited number of elements in a certain topology by way of example, the embodiment may include more or less elements in alternate topologies as desired for a given implementation. It is worthy to note that any reference to “one embodiment” or “an embodiment” means that a particular feature, structure, or characteristic described in connection with the embodiment is included in at least one embodiment. The appearances of the phrases “in one embodiment,” “in some embodiments,” and “in various embodiments” in various places in the specification are not necessarily all referring to the same embodiment.

Embodiments herein are generally directed to wireless communications systems. Various embodiments are particularly directed to wireless communications performed according to one or more wireless communications standards. Examples of wireless communications technologies and/or standards that may be used in various embodiments may include—without limitation—IEEE wireless communication standards such as the IEEE 802.11, IEEE 802.11a, IEEE 802.11b, IEEE 802.11g, IEEE 802.11n, IEEE 802.11u, IEEE 802.11ac, IEEE 802.11 ad, IEEE 802.11af, and/or IEEE 802.11ah standards, High-Efficiency Wi-Fi standards developed by the IEEE 802.11 High Efficiency WLAN (HEW) Study Group, Wi-Fi Alliance (WFA) wireless communication standards such as Wi-Fi, Wi-Fi Direct, Wi-Fi Direct Services, Wireless Gigabit (“WiGig”), WiGig Display Extension (WDE), WiGig Bus Extension (WBE), WiGig Serial Extension (WSE) standards and/or standards developed by the WFA Neighbor Awareness Networking (NAN) Task Group. Some embodiments may involve wireless communications performed according to one or more next-generation 60 GHz (“NG60”) wireless local area network (WLAN) communications standards and/or one or more millimeter-wave (mmWave) wireless communication standards.

Various embodiments may involve wireless communications performed according to one or more broadband wireless communications standards. For example, various embodiments may involve wireless communications performed according to one or more 3rd Generation Partnership Project (3GPP), 3GPP Long Term Evolution (LTE), and/or 3GPP LTE-Advanced (LTE-A) technologies and/or standards, including their predecessors, revisions, progeny, and/or variants. Additional examples of broadband wireless communication technologies/standards that may be utilized in some embodiments may include—without limitation—Global System for Mobile Communications (GSM)/Enhanced Data Rates for GSM Evolution (EDGE), Universal Mobile Telecommunications System (UMTS)/High Speed Packet Access (HSPA), and/or GSM with General Packet Radio Service (GPRS) system (GSM/GPRS), IEEE 802.16 wireless broadband standards such as IEEE 802.16m and/or IEEE 802.16p, International Mobile Telecommunications Advanced (IMT-ADV), Worldwide Interoperability for Microwave Access (WiMAX) and/or WiMAX II, Code Division Multiple Access (CDMA) 2000 (e.g., CDMA2000 1×RTT, CDMA2000 EV-DO, CDMA EV-DV, and so forth), High Performance Radio Metropolitan Area Network (HIPERMAN), Wireless Broadband (WiBro), High Speed Downlink Packet Access (HSDPA), High Speed Orthogonal Frequency-Division Multiplexing (OFDM) Packet Access (HSOPA), High-Speed Uplink Packet Access (HSUPA) technologies and/or standards, including their predecessors, revisions, progeny, and/or variants. Further examples of wireless communications technologies and/or standards that may be used in various embodiments may include—without limitation—machine-type communications (MTC) standards such as those embodied in 3GPP Technical Report (TR) 23.887, 3GPP Technical Specification (TS) 22.368, and/or 3GPP TS 23.682, and/or near-field communication (NFC) standards such as standards developed by the NFC Forum, including any predecessors, revisions, progeny, and/or variants of any of the above.

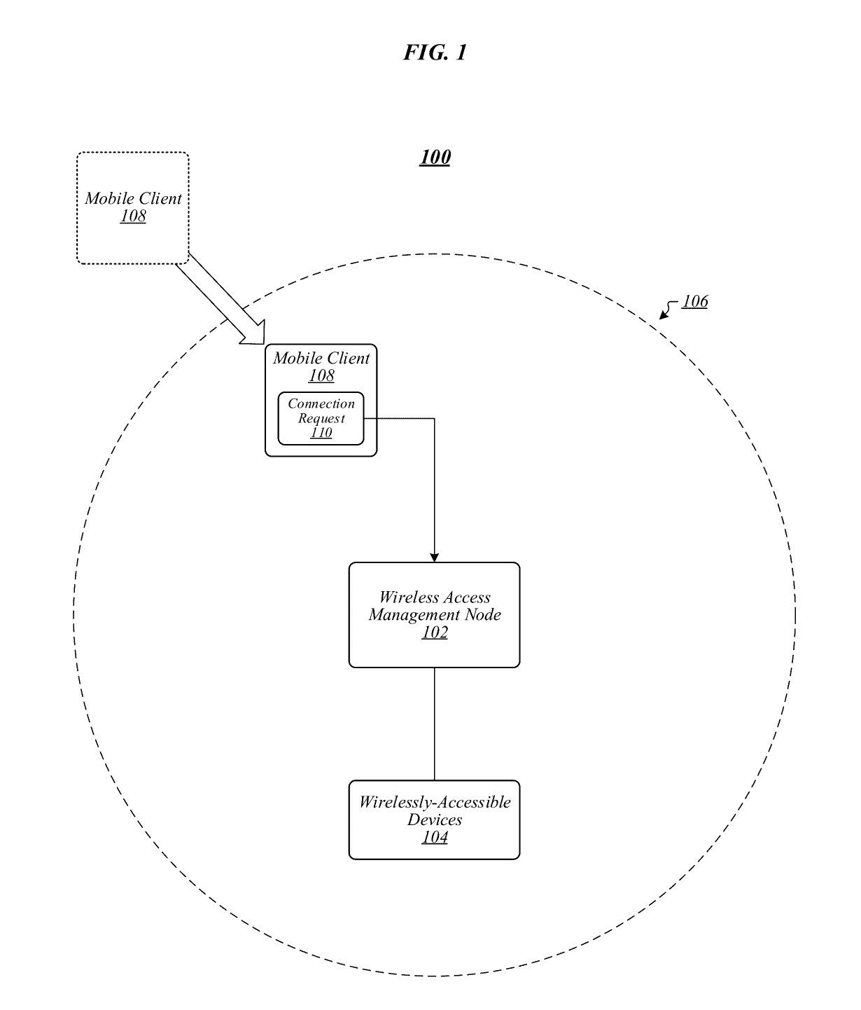

FIG. 1 illustrates an example of an operating environment 100 such as may be representative of some embodiments. In operating environment 100, a wireless access management node 102 generally enables and manages wireless access to one or more wirelessly-accessible devices 104. More particularly, wireless access management node 102 enables capable devices within a connection range 106 to obtain wireless access to wirelessly-accessible devices 104. In various embodiments, wireless access management node 102 may comprise/feature a wireless dock, and wirelessly-accessible devices 104 may comprise peripherals that may be accessed via the wireless dock. In some such embodiments, wireless access management node 102 may comprise an all-in-one (AIO) computer or computing system that features an integrated wireless dock. Hereinafter, the term “AIO dock” shall be employed to denote such an integrated wireless dock. In various other embodiments, wireless access management node 102 may comprise a node providing connectivity with a wireless network, and wirelessly-accessible devices 104 may comprise devices in that wireless network. For example, in some embodiments, wirelessly-accessible devices 104 may comprise devices in a wireless local area network (WLAN), and wireless access management node 102 may comprise a wireless router that provides connectivity with that WLAN. It is worthy of note that wirelessly-accessible devices 104 need not necessarily possess wireless communication capabilities. For example, in various embodiments, wirelessly-accessible devices 104 may comprise peripherals that are communicatively coupled to wireless access management node 102 via universal serial bus (USB) connections. The embodiments are not limited in this context.

In operating environment 100, a mobile client 108 moves from a position outside of the connection range 106 of wireless management node 102 to a position within that connection range 106. After entering connection range 106, the mobile client 108 sends a connection request 110 to wireless access management node 102 in order to request access to wirelessly-accessible devices 104. In some embodiments, connection request 110 may be generated in response to user input received following the entry of mobile client 108 into the connection range 106 of wireless access management node 102. Hereinafter, the term “manual connection request” shall be employed to denote a connection request that is generated in response to such user input. In an example embodiment, wireless access management node 102 may comprise a wireless dock, and once mobile client 108 has moved to within connection range 106 of that wireless dock, a user of mobile client 108 may enter input indicating that use of the wireless dock is desired. In this example, connection request 110 may comprise a manual connection request that is generated in response to receipt of that user input. The embodiments are not limited to this example.

In various embodiments, connection request 110 may be automatically generated following the entry of mobile client 108 into connection range 106 of wireless access management node 102. Hereinafter, the term “automatic connection request” shall be employed to denote a connection request that is automatically generated in such a fashion. In an example embodiment, wireless access management node 102 may comprise a wireless dock, and mobile client 108 may previously have been configured to automatically connect to that wireless dock when it is within range. In this example, connection request 110 may be automatically generated at mobile client 108 in response to a determination that mobile client 108 has entered connection range 106 of wireless access management node 102. It is worthy of note that in some embodiments, the automatic generation of an automatic connection request may result from previously received user input. For example, in operating environment 100, a user of mobile client 108 may previously have entered input in order to configure mobile client 108 to automatically connect to wireless access management node 102. Upon subsequently entering connection range 106 of wireless access management node 102, mobile client 108 may then automatically generate connection request 110 based on that previously-specified configuration. The embodiments are not limited to this example.

In various embodiments, the manner in which wireless access management node 102 may best handle connection request 110 may depend on whether connection request 110 is an automatic connection request or a manual connection request. For example, if wireless access management node 102 is a wireless dock, it may be desirable—in order to avoid unnecessarily disconnecting a current user and/or unnecessarily draining battery power at mobile client 108—that wireless access management node 102 require some form of confirmation before granting a connection request 110 that is automatically generated and thus not representative of an explicit user request for use of the dock. On the other hand, with respect to an explicit user-generated request to use the dock, it may be assumed that wireless access management node 102 may defer to the discretion of the requesting user, and thus it may be desirable that additional confirmation not be required. As such, it may be desirable that wireless access management node 102 consider whether connection request 110 has been generated automatically or manually when determining how to handle connection request 110.

Disclosed herein are wireless access management techniques for wirelessly-accessible devices. According to some such techniques, information may be included within a connection request such as connection request 110 in order to indicate whether that connection request has been automatically or manually generated. In various embodiments, this information may be in the form of a defined information element (IE). In some embodiments, in addition to—or rather than—being included within such a connection request message, such a defined IE may be included in one or more other types of messages that a mobile client, such as mobile client 108, may exchange with a wireless access management node such as wireless access management node 102. In various embodiments, a wireless access management node may determine how to proceed in response to a received connection request based on a determination of whether that connection request was automatically or manually generated. The embodiments are not limited in this context.

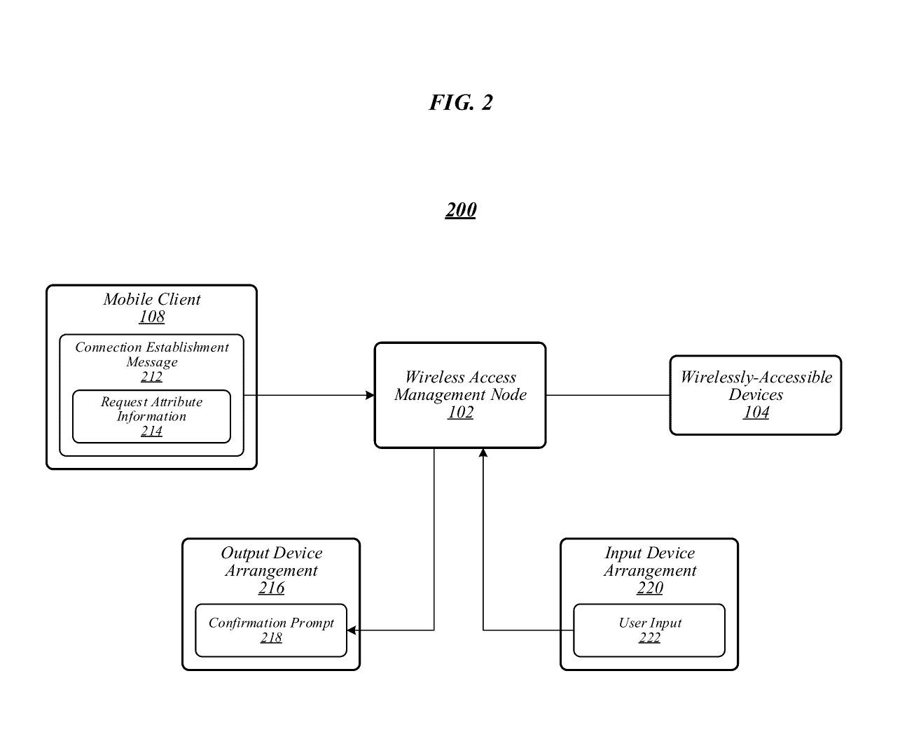

FIG. 2 illustrates an operating environment 200 that may be representative of the implementation of wireless access management techniques for wirelessly-accessible devices in some embodiments. In operating environment 200, as part of a procedure for requesting and establishing a connection with wireless access management node 102 in order to use wirelessly-accessible devices 104, mobile client 108 sends a connection establishment message 212. In various embodiments, connection establishment message 212 may comprise a connection request message, such as connection request 110 of FIG. 1. In some embodiments, connection establishment message 212 may comprise another type of message that mobile client 108 sends to wireless access management node 102 in conjunction with establishing a connection via which to use wirelessly-accessible devices 104. The embodiments are not limited in this context.

In various embodiments, connection establishment message 212 may comprise a message constructed according to a standard-defined format. In some embodiments, for example, connection establishment message 212 may comprise a message defined in a Wi-Fi P2P standard, such as Wi-Fi P2P Technical Specification ver. 1.5, released Aug. 4, 2014, its revisions, progeny, and/or variants. In various such embodiments, connection establishment message 212 may comprise a Provision Discovery Request frame, a Group Owner (GO) Negotiation Request frame, or a P2P Invitation Request frame. In some embodiments, connection establishment message 212 may comprise a message defined in an IEEE 802.11 standard, a 3GPP standard, or another type of wireless communication standard. In various other embodiments, connection establishment message 212 may comprise a message constructed according to another type of defined format, such as a vendor-defined format. The embodiments are not limited in this context.

In some embodiments, connection establishment message 212 may comprise request attribute information 214. Request attribute information 214 may generally comprise information that indicates whether a connection request—which may be connection establishment message 212 itself or may be a connection request with which connection establishment message 212 is associated —is an automatic connection request or a manual connection request. In various embodiments, request attribute information 214 may comprise a standard-defined information element (IE). In some embodiments, request attribute information 214 may comprise an IE defined in a Wi-Fi P2P standard. In various other embodiments, request attribute information 214 may comprise an IE defined in an IEEE 802.11 standard, a 3GPP standard, or another type of wireless communication standard. In still other embodiments, request attribute information 214 may comprise an IE constructed according to another type of defined format, such as a vendor-defined format. The embodiments are not limited in this context.

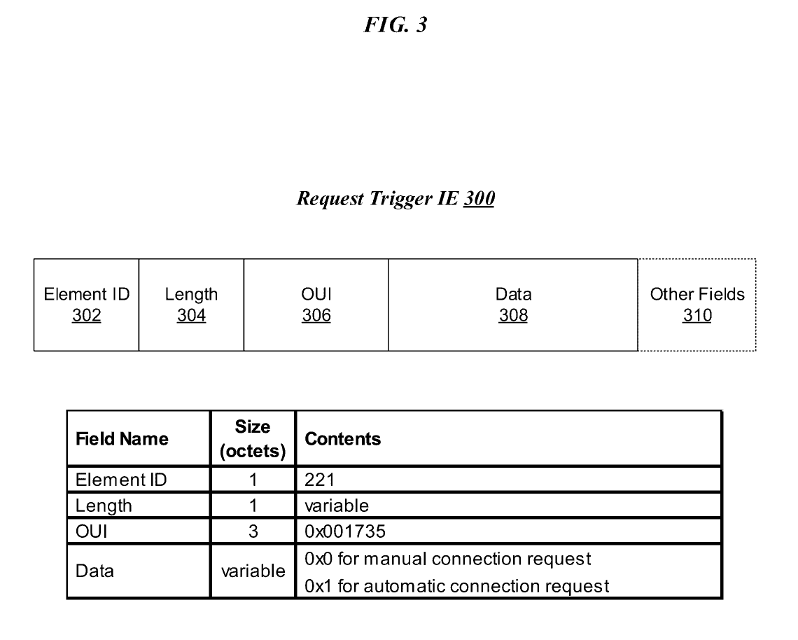

FIG. 3 illustrates a Request Trigger IE 300 that may comprise a representative example of request attribute information 214 of FIG. 2 according to some embodiments. In this example, Request Trigger IE 300 is structured based on a P2P IE format as defined in Wi-Fi P2P Technical Specification ver. 1.5, according to which the P2P IE format is in turn based on a Vendor Specific IE format as defined in IEEE 802.11-2012, released Mar. 29, 2012. It is to be appreciated that the depicted fields, including their field names and values, as well as the IE name “Request Trigger” are purely exemplary, and that the embodiments are not limited to these examples.

In the example of FIG. 3, Request Trigger IE 300 comprises an Element Identifier (ID) field 302, a Length field 304, an Organizationally Unique Identifier (OUI) field 306, and a Data field 308. In various embodiments, request trigger IE 300 may also comprise one or more other fields 310. It is worthy of note that although the other fields 310 are depicted as exclusively appearing following Data field 308 in this example, the embodiments are not so limited. For example, in some embodiments, Request Trigger IE 300 may include an additional field 310 that is located between OUI field 306 and Data field 308. The embodiments are not limited to this example.

In various embodiments, Element ID field 302 may comprise a size of one octet. In some embodiments, Element ID field 302 may comprise a value indicating a type of IE that Request Trigger IE 300 constitutes. In various embodiments, Element ID field 302 may comprise a value of 221, to indicate that Request Trigger IE 300 comprises a vendor-specific P2P IE. In some embodiments, Length field 304 may comprise a size of one octet. In various embodiments, Length field 304 may comprise a value indicating a total length of Request Trigger IE 300, which may be indicated in units of octets. In some embodiments, the value of Length field 304 may thus depend on the overall size of Request Trigger IE 300, which in turn may depend on the size of Data field 308 and/or the sizes of any additional fields 310 that are contained within Request Trigger IE 300.

In various embodiments, OUI field 306 may comprise a size of three octets. In some embodiments, OUI field 306 may comprise a value identifying a defining entity—which may be a standard-defining body such as the Wi-Fi Alliance (WFA) or may be a vendor, for example—of a protocol according to which the information in Data field 308 is to be interpreted. In various embodiments, OUI field 306 may comprise a value of 0x001735, or another value according to an implementing vendor. In some embodiments, Data field 308 may contain a value specifying whether a connection request associated with Request Trigger IE 300 comprises a manual connection request or an automatic connection request. In various embodiments, a value of 0x0 may indicate a manual connection request, and a value of 0x 1 may indicate an automatic connection request. In some other embodiments, a value of 0x0 may indicate an automatic connection request, while a value of 0x0 may indicate a manual connection request. In various embodiments, Data field 308 may contain other values and/or subfields, and the size of Data field 308 may be variable. The embodiments are not limited in this context.

Returning to FIG. 2, in some embodiments, wireless access management node 102 may perform a connection request handling procedure in response to receipt of a connection request from mobile client 108. In various embodiments, according to the connection request handling procedure, wireless access management node 102 may consider whether the received connection request constitutes an automatic connection request or a manual connection request in conjunction with determining how to handle the received connection request. In some such embodiments, wireless access management node 102 may determine whether the received connection request is an automatic request or a manual request based on request attribute information 214. In various embodiments, request attribute information 214 may comprise an IE such as Request Trigger IE 300 of FIG. 3, and wireless access management node 102 may determine whether the connection request is an automatic connection request or a manual connection request based on a value comprised in that IE. In some embodiments, according to the connection request handling procedure, a determination of how to handle a manual connection request may include a consideration of whether the requesting device is authorized to manually request connection establishment without need for confirmation. The embodiments are not limited in this context.

Operations for the above embodiments may be further described with reference to the following figures and accompanying examples. Some of the figures may include a logic flow. Although such figures presented herein may include a particular logic flow, it can be appreciated that the logic flow merely provides an example of how the general functionality as described herein can be implemented. Further, the given logic flow does not necessarily have to be executed in the order presented unless otherwise indicated. In addition, the given logic flow may be implemented by a hardware element, a software element executed by a processor, or any combination thereof. The embodiments are not limited in this context.

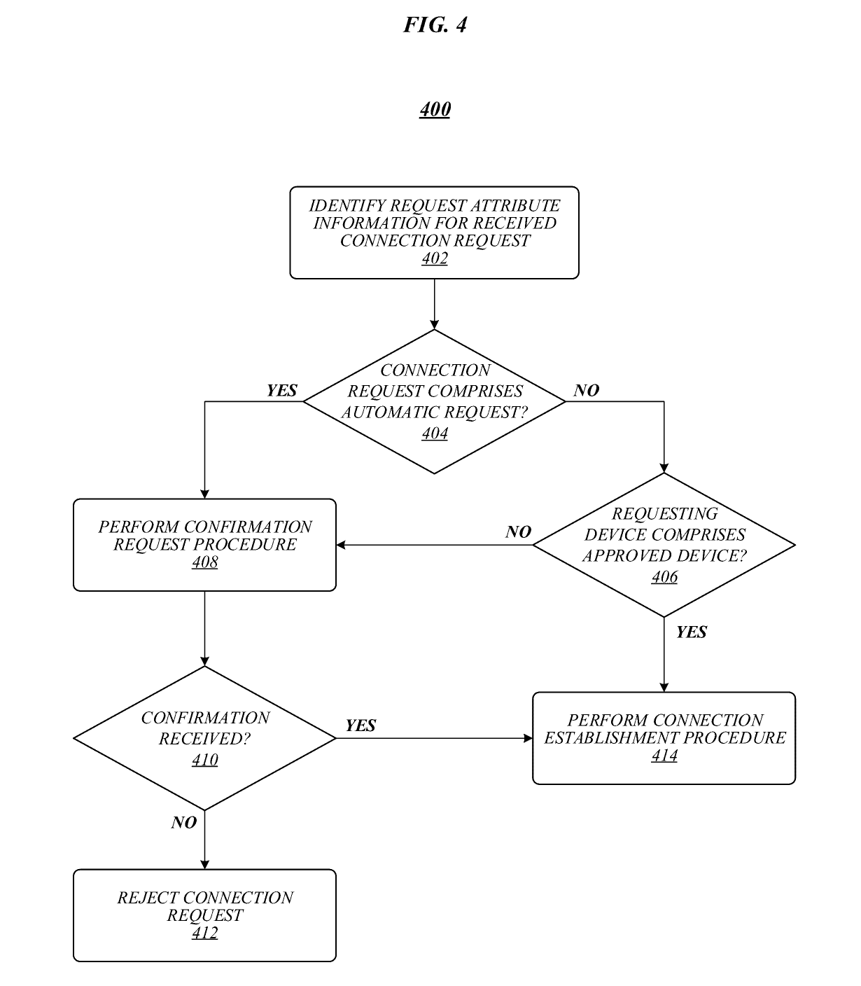

FIG. 4 illustrates an embodiment of a logic flow 400, which may be representative of an example of a connection request handling procedure that wireless access management node 102 of FIG. 2 may perform in various embodiments in order to handle a connection request received from mobile client 108. As shown in FIG. 4, request attribute information for a received connection request may be identified at 402. In some embodiments, the connection request may comprise a request for wireless connectivity to one or more wirelessly-accessible devices. For example, wireless access management node 102 of FIG. 2 may identify request attribute information 214 for a received request, on the part of mobile client 108, for wireless connectivity to one or more wirelessly-accessible devices 104. In various embodiments, connection establishment message 212 may itself constitute that received connection request. In some other embodiments, the received connection request may comprise a distinct message with which connection establishment message 212 is associated. The embodiments are not limited in this context.

At 404, based on the request attribute information, a determination may be made of whether the received connection request comprises an automatic connection request. For example, wireless access management node 102 of FIG. 2 may determine whether the received connection request is an automatic connection request based on a value comprised in request attribute information 214. If it is determined at 404 that the connection request does not comprise an automatic connection request, flow may pass to 406. At 406, a determination may be made of whether a requesting device that has submitted the connection request is an approved device that has authorization to manually request connectivity to the one or more wirelessly-accessible devices. For example, wireless access management node 102 of FIG. 2 may determine whether mobile client 108 is an approved device that is allowed to connect manually to one or more wirelessly-accessible devices 104 without confirmation. If it is determined that the requesting device comprises an approved device, flow may pass to 414. At 414, a connection establishment procedure may be performed in order to provide the requesting device with wireless connectivity to the one or more wirelessly-accessible devices. For example, wireless access management node 102 of FIG. 2 may perform a connection establishment procedure in order to provide mobile client 108 with wireless connectivity to one or more wirelessly-accessible devices 104. If it is determined at 406 that the requesting device does not comprise an approved device, flow may pass to 408. Flow may also pass to 408 directly from 404 in response to a determination at 404 that the connection request comprises a manual connection request.

At 408, a confirmation request procedure may be performed. For example, wireless access management node 102 of FIG. 2 may perform a confirmation request procedure in response to a determination that connection establishment message 212 is associated with an automatic connection request or a determination that mobile client 108 does not comprise an approved device. In various embodiments, the confirmation request procedure may comprise generating a prompt for user confirmation that the connection request should be granted. From 408, flow may pass to 410, and then on to either 412 or 414 depending on whether a confirmation has been received that indicates that the connection request is to be granted. If it is determined at 410 that such a confirmation has been received, flow may pass to 414, where a connection establishment procedure may be performed in order to provide the requesting device with wireless connectivity to the one or more wireles sly-accessible devices, as previously discussed. If it is determined at 410 that no such confirmation has been received, flow may pass to 412, where the connection request may be rejected. For example, if it initiates a confirmation request procedure but does not receive a confirmation as a result, wireless access management node 102 of FIG. 2 may reject the connection request associated with connection establishment message 212. The embodiments are not limited to these examples.

Returning to FIG. 2, in some embodiments—as noted in the above example in reference to logic flow 400 of FIG. 4—wireless access management node 102 may perform a confirmation request procedure in response to a determination that the connection request corresponding to connection establishment message 212 comprises an automatic connection request, or in response to a determination that mobile client 108 is not an approved device. In various embodiments, during the confirmation request procedure, wireless access management node 102 may cause a confirmation prompt 218 to be presented by an output device arrangement 216. In some embodiments, confirmation prompt 218 may comprise a prompt for user confirmation that the connection request should be granted. In various embodiments, output device arrangement 216 may comprise a set of one or more devices that are collectively configured with the ability to generate any visual, audio, tactile, and/or other sensory effects that are necessary in order to present confirmation prompt 218.

In some embodiments, confirmation prompt 218 may comprise a visual prompt, such as an alert window or dialog box, and output device arrangement 216 may comprise one or more display devices such as monitors, televisions, or computing device screens. In various embodiments, confirmation prompt 218 may comprise an audio prompt, such as a computer-generated speech prompt or tone, and output device arrangement 216 may comprise one or more audio devices, such as speakers. In some embodiments, confirmation prompt 218 may comprise a tactile prompt, such as a message in the form of tactile feedback, and output device arrangement 216 may comprise one or more tactile feedback devices. In various embodiments, confirmation prompt 218 may consist of a combination of sensory effects, and output device arrangement 216 may include a combination of respective devices capable of generating those effects. For example, in some embodiments, confirmation prompt 218 may consist of both a dialog box and an alert tone, and output device arrangement 216 may comprise a display device on which the dialog box is presented and a set of speakers by which the alert tone is generated. The embodiments are not limited to this example.

In various embodiments, some or all of output device arrangement 216 may be comprised in wireless access management node 102. For example, in some embodiments in which wireless access management node 102 is an AIO computing system, output device arrangement 216 may be a display device comprised in that AIO computing system. In various embodiments, output device arrangement 216 may include one or more of wirelessly-accessible devices 104. For example, in some embodiments, output device arrangement 216 may include speakers that are comprised among wirelessly-accessible devices 104. In various embodiments, output device arrangement 216 may include one or more devices comprised in wireless access management node 102 as well as one or more devices comprised among wirelessly-accessible devices 104. In some embodiments, output device arrangement 216 may include neither any devices comprised in wireless access management node 102 nor any devices comprised among wirelessly-accessible devices 104. The embodiments are not limited in this context.

In various embodiments, following the generation of confirmation prompt 218 during the confirmation request procedure, wireless access management node 102 may monitor an input device arrangement 220 for user input 222. In some embodiments, input device arrangement 220 may comprise a set of one or more devices that are collectively configured with the ability to accept user inputs to be received in response to confirmation prompt 218. Examples of devices that may be comprised in input device arrangement 220 in various embodiments may include—without limitation—a mouse, a keyboard, a joystick, a trackball, a touch pad, a tactile input device, an audio input device such as a microphone, and a biometric input device such as a fingerprint scanner or retinal scanner. Like output device arrangement 216, input device arrangement 220 may be partially or completely comprised in wireless access management node 102 and/or among wirelessly-accessible devices 104 in some embodiments. In various other embodiments, input device arrangement 220 may be entirely external to both wireless access management node 102 and wirelessly-accessible devices 104. In some embodiments, a same device may comprise some or all of both output device arrangement 216 and input device arrangement 220. For example, in various embodiments, a same touchscreen display—which may or may not be comprised in wireless access management node 102 or among wirelessly-accessible devices 104—may both serve as output device arrangement 216 by displaying confirmation prompt 218 and serve as input device arrangement 220 by accepting user inputs 222 in response to confirmation prompt 218. The embodiments are not limited to this example.

In some embodiments, wireless access management node 102 may analyze user input 222 in order to determine whether it has received user confirmation that the connection request associated with connection establishment message 212 should be granted. In various embodiments, in response to a determination—based on user input 222—that user confirmation has been received, wireless access management node 102 may initiate a connection establishment procedure in order to provide mobile client 108 with wireless connectivity to wirelessly-accessible devices 104. In some such embodiments, in conjunction with the connection establishment procedure, the existing wireless connectivity of another mobile client to wirelessly-accessible devices 104 may be discontinued in order to free wirelessly-accessible devices 104 for use by mobile client 108. In various embodiments, in response to a determination—based on user input 222—that user confirmation has not been received, wireless access management node 102 may reject the connection request associated with connection establishment message 212. In some embodiments, in conjunction with rejecting the connection request associated with connection establishment message 212, wireless access management node 102 may maintain the existing wireless connectivity of another mobile client to wirelessly-accessible devices 104. In various embodiments, if no user input 222 has been received within a certain amount of time following the presentation of confirmation prompt 218, wireless access management node 102 may stop monitoring input device arrangement 220 for user inputs and reject the connection request. The embodiments are not limited in this context.

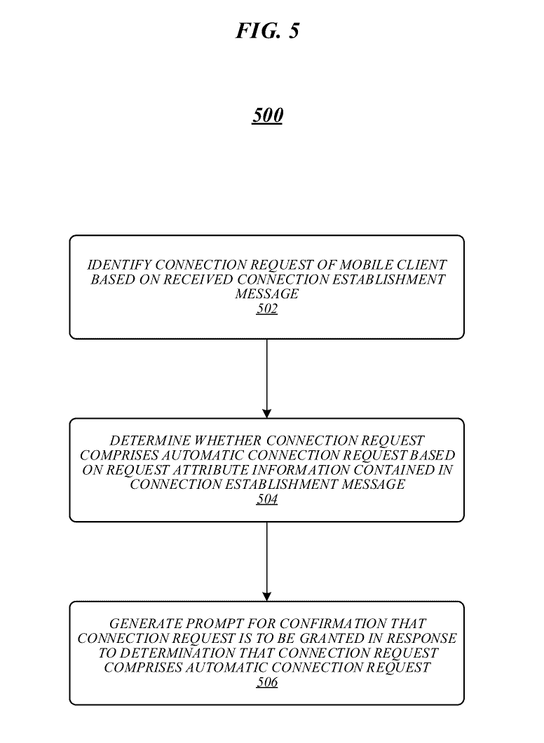

FIG. 5 illustrates an embodiment of a logic flow 500 that may be representative of operations that may be performed in some embodiments by wireless access management node 102 of FIG. 2. As shown in FIG. 5, a connection request of a mobile client may be identified based on a received connection establishment message at 502. For example, wireless access management node 102 of FIG. 2 may identify a connection request of mobile client 108 based on a received connection establishment message 212. At 504, based on request attribute information contained in the connection establishment message, a determination may be made of whether the connection request comprises an automatic connection request. For example, wireless access management node 102 of FIG. 2 may determine whether the connection request associated with connection establishment message 212 comprises an automatic connection request based on request attribute information 214 comprised in connection establishment message 212. At 506, in response to a determination that the connection request comprises an automatic connection request, a prompt may be generated for confirmation that the connection request is to be granted. For example, in response to a determination that the connection request associated with connection establishment message 212 comprises an automatic connection request, wireless access management node 102 of FIG. 2 may generate confirmation prompt 218. The embodiments are not limited to these examples.

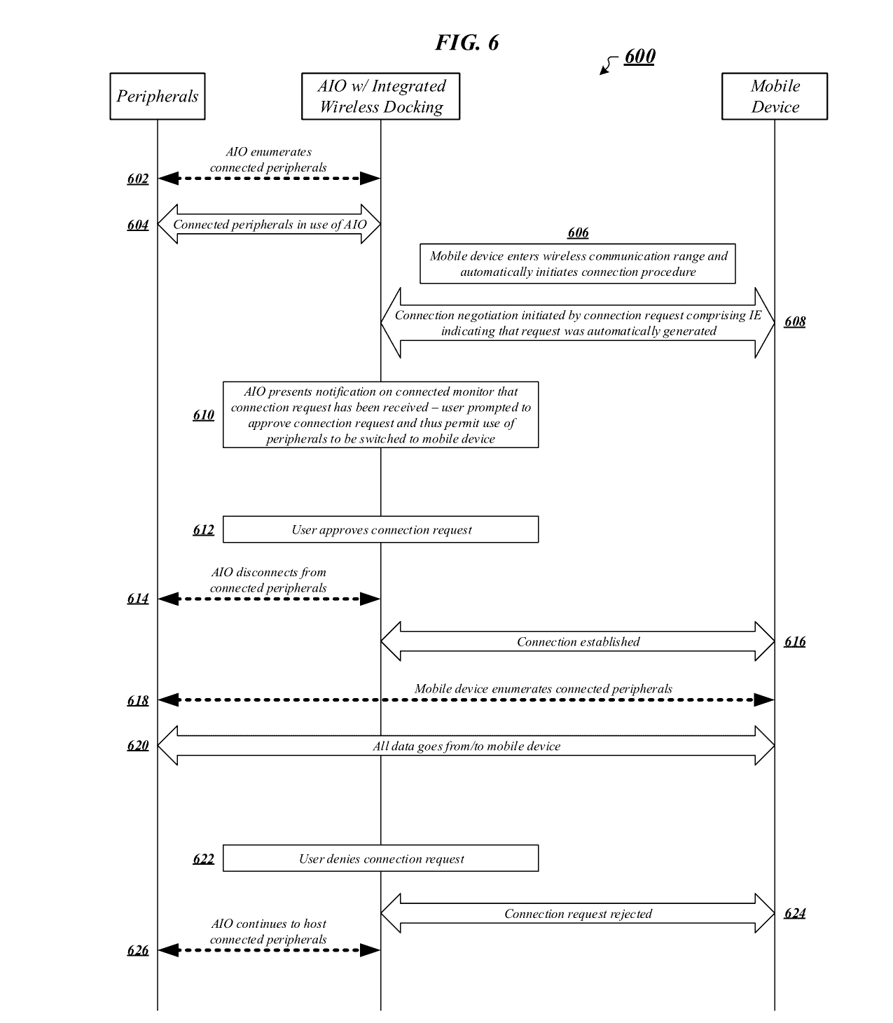

FIG. 6 illustrates an embodiment of an operational flow 600 that may be representative of various embodiments. More particularly, operational flow 600 may comprise a non-limiting representative example of an embodiment in which an automatic connection request is handled according to one or more of the disclosed wireless access management techniques for wirelessly-accessible devices. As reflected in FIG. 6, operational flow 600 generally involves a scenario in which a set of peripherals connected to an AIO are wirelessly-accessible via a wireless dock integrated within the AIO, and a mobile device automatically requests wireless connectivity to the connected peripherals via the AIO dock.

As shown in FIG. 6, the AIO enumerates the connected peripherals at 602, after which the connected peripherals are in the use of the AIO, as reflected at 604. At 606, the mobile device enters wireless communication range of the AIO dock and automatically initiates a connection procedure. At 608, the mobile device performs connection negotiation with the AIO dock. The mobile device initiates that connection negotiation by sending a connection request comprising an IE indicating that the connection request has been automatically generated. At 610, the AIO presents a notification on a connected monitor that a connection request has been received, and prompts a user to approve the connection request and thus permit use of the connected peripherals to be switched to the mobile device. The monitor on which this notification is presented may or may not be comprised among the set of connected peripherals to which the mobile device has requested wireless access.

From 610, flow may pass to 612, where the user may approve the connection request. In such a case, the AIO may then disconnect from the connected peripherals at 614. At 616, the mobile device may establish wireless connectivity with the AIO dock. At 618, the mobile device may enumerate the connected peripherals, after which all data to/from the connected peripherals may go from/to the mobile device, as reflected at 620. From 610, rather than passing to 612, flow may pass to 622, where the user may deny the connection request. At 624, the AIO dock may communicate with the mobile device in order to inform the mobile device of the rejection of the connection request. As reflected at 626, as a result of the denial of the connection request, the AIO may continue to host the set of connected peripherals. The embodiments are not limited to this example.

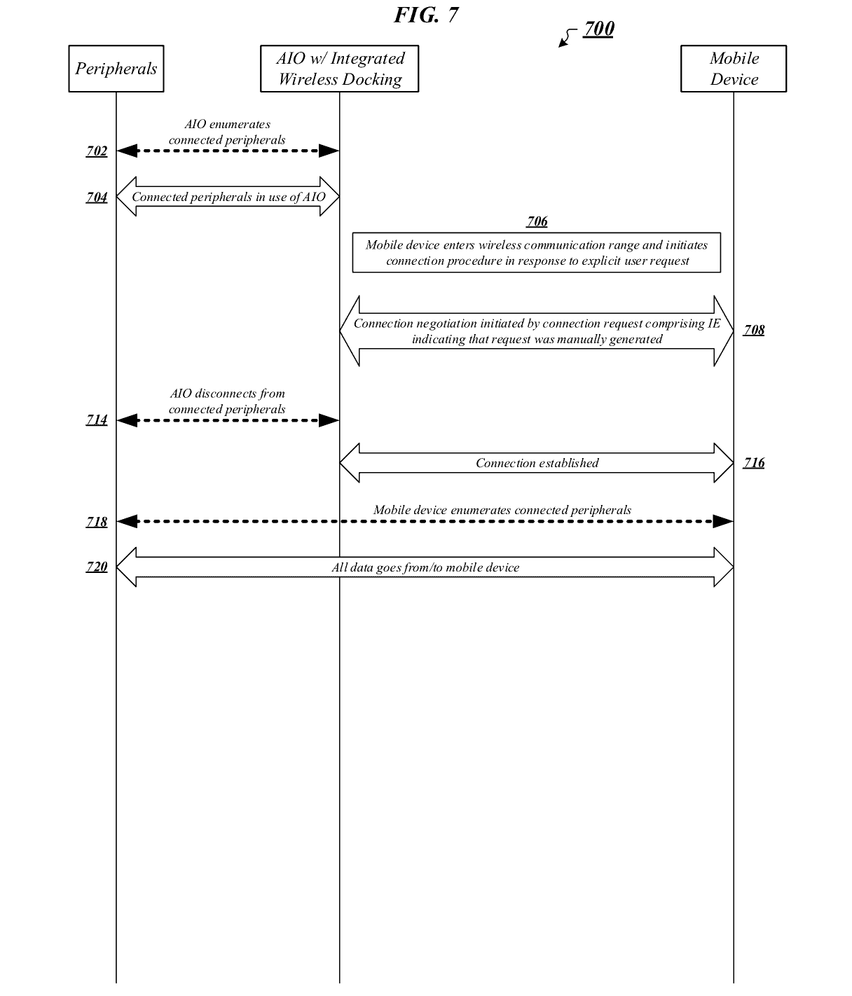

FIG. 7 illustrates an embodiment of an operational flow 700 that may be representative of some embodiments. More particularly, operational flow 700 may comprise a non-limiting representative example of an embodiment in which a manual connection request is handled according to one or more of the disclosed wireless access management techniques for wirelessly-accessible devices. Operational flow 700 generally involves a scenario in which a user of the mobile device of FIG. 6 explicitly requests wireless connectivity to the connected peripherals via the AIO dock therein.

As shown in FIG. 7, the AIO enumerates the connected peripherals at 702, after which the connected peripherals are in the use of the AIO, as reflected at 704. At 706, the mobile device enters wireless communication range of the AIO dock, and initiates a connection procedure in response to an explicit user request. At 708, the mobile device performs connection negotiation with the AIO dock. The mobile device initiates that connection negotiation by sending a connection request comprising an IE indicating that the connection request has been manually generated. At 714, the AIO may then disconnect from the connected peripherals. At 716, the mobile device may establish wireless connectivity with the AIO dock. At 718, the mobile device may enumerate the connected peripherals, after which all data to/from the connected peripherals may go from/to the mobile device, as reflected at 720. The embodiments are not limited to this example.

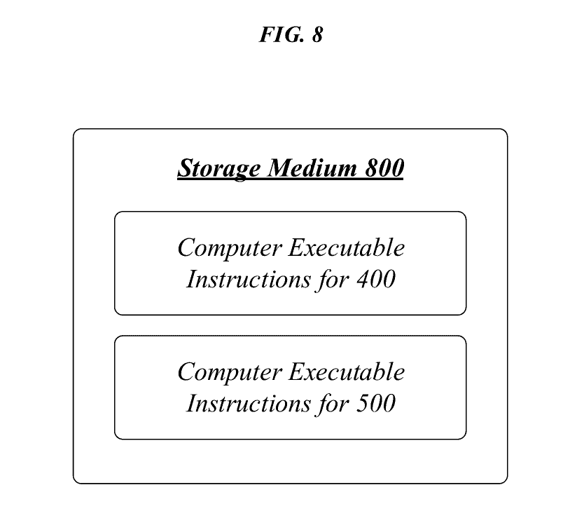

FIG. 8 illustrates an embodiment of a storage medium 800. Storage medium 800 may comprise any non-transitory computer-readable storage medium or machine-readable storage medium, such as an optical, magnetic or semiconductor storage medium. In various embodiments, storage medium 800 may comprise an article of manufacture. In some embodiments, storage medium 800 may store computer-executable instructions, such as computer-executable instructions to implement one or more of logic flow 400 of FIG. 4 and logic flow 500 of FIG. 5. Examples of a computer-readable storage medium or machine-readable storage medium may include any tangible media capable of storing electronic data, including volatile memory or non-volatile memory, removable or non-removable memory, erasable or non-erasable memory, writeable or re-writeable memory, and so forth. Examples of computer-executable instructions may include any suitable type of code, such as source code, compiled code, interpreted code, executable code, static code, dynamic code, object-oriented code, visual code, and the like. The embodiments are not limited in this context.

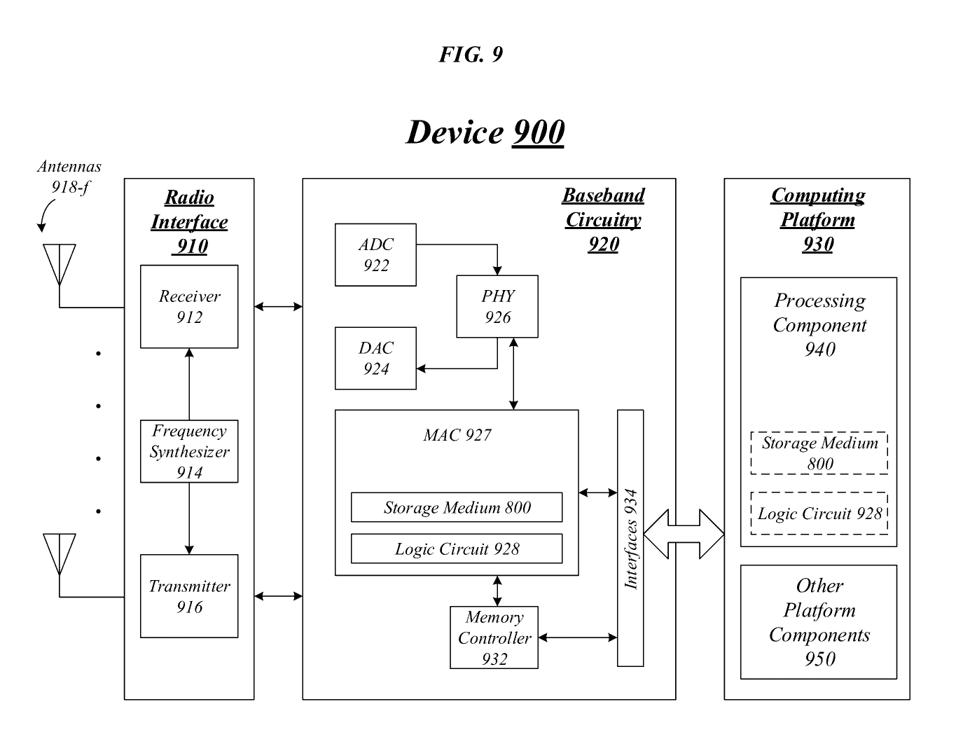

FIG. 9 illustrates an embodiment of a communications device 900 that may implement one or more of wireless access management node 102 and mobile client 108 of FIGS. 1 and 2, logic flow 400 of FIG. 4, logic flow 500 of FIG. 5, and storage medium 800 of FIG. 8. In various embodiments, device 900 may comprise a logic circuit 928. The logic circuit 928 may include physical circuits to perform operations described for one or more of wireless access management node 102 and mobile client 108 of FIGS. 1 and 2, logic flow 400 of FIG. 4, and logic flow 500 of FIG. 5, for example. As shown in FIG. 9, device 900 may include a radio interface 910, baseband circuitry 920, and computing platform 930, although the embodiments are not limited to this configuration.

The device 900 may implement some or all of the structure and/or operations for one or more of wireless access management node 102 and mobile client 108 of FIGS. 1 and 2, logic flow 400 of FIG. 4, logic flow 500 of FIG. 5, storage medium 800 of FIG. 8, and logic circuit 928 in a single computing entity, such as entirely within a single device. Alternatively, the device 900 may distribute portions of the structure and/or operations for one or more of wireless access management node 102 and mobile client 108 of FIGS. 1 and 2, logic flow 400 of FIG. 4, logic flow 500 of FIG. 5, storage medium 800 of FIG. 8, and logic circuit 928 across multiple computing entities using a distributed system architecture, such as a client-server architecture, a 3-tier architecture, an N-tier architecture, a tightly-coupled or clustered architecture, a peer-to-peer architecture, a master-slave architecture, a shared database architecture, and other types of distributed systems. The embodiments are not limited in this context.

In one embodiment, radio interface 910 may include a component or combination of components adapted for transmitting and/or receiving single-carrier or multi-carrier modulated signals (e.g., including complementary code keying (CCK), orthogonal frequency division multiplexing (OFDM), and/or single-carrier frequency division multiple access (SC-FDMA) symbols) although the embodiments are not limited to any specific over-the-air interface or modulation scheme. Radio interface 910 may include, for example, a receiver 912, a frequency synthesizer 914, and/or a transmitter 916. Radio interface 910 may include bias controls, a crystal oscillator and/or one or more antennas 918-f. In another embodiment, radio interface 910 may use external voltage-controlled oscillators (VCOs), surface acoustic wave filters, intermediate frequency (IF) filters and/or RF filters, as desired. Due to the variety of potential RF interface designs an expansive description thereof is omitted.

Baseband circuitry 920 may communicate with radio interface 910 to process receive and/or transmit signals and may include, for example, an analog-to-digital converter 922 for down converting received signals, a digital-to-analog converter 924 for up converting signals for transmission. Further, baseband circuitry 920 may include a baseband or physical layer (PHY) processing circuit 926 for PHY link layer processing of respective receive/transmit signals. Baseband circuitry 920 may include, for example, a medium access control (MAC) processing circuit 927 for MAC/data link layer processing. Baseband circuitry 920 may include a memory controller 932 for communicating with MAC processing circuit 927 and/or a computing platform 930, for example, via one or more interfaces 934.

In some embodiments, PHY processing circuit 926 may include a frame construction and/or detection module, in combination with additional circuitry such as a buffer memory, to construct and/or deconstruct communication frames. Alternatively or in addition, MAC processing circuit 927 may share processing for certain of these functions or perform these processes independent of PHY processing circuit 926. In some embodiments, MAC and PHY processing may be integrated into a single circuit.

The computing platform 930 may provide computing functionality for the device 900. As shown, the computing platform 930 may include a processing component 940. In addition to, or alternatively of, the baseband circuitry 920, the device 900 may execute processing operations or logic for one or more of wireless access management node 102 and mobile client 108 of FIGS. 1 and 2, logic flow 400 of FIG. 4, logic flow 500 of FIG. 5, storage medium 800 of FIG. 8, and logic circuit 928 using the processing component 940. The processing component 940 (and/or PHY 926 and/or MAC 927) may comprise various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

The computing platform 930 may further include other platform components 950. Other platform components 950 include common computing elements, such as one or more processors, multi-core processors, co-processors, memory units, chipsets, controllers, peripherals, interfaces, oscillators, timing devices, video cards, audio cards, multimedia input/output (I/O) components (e.g., digital displays), power supplies, and so forth. Examples of memory units may include without limitation various types of computer readable and machine readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information.

Device 900 may be, for example, an ultra-mobile device, a mobile device, a fixed device, a machine-to-machine (M2M) device, a personal digital assistant (PDA), a mobile computing device, a smart phone, a telephone, a digital telephone, a cellular telephone, user equipment, eBook readers, a handset, a one-way pager, a two-way pager, a messaging device, a computer, a personal computer (PC), a desktop computer, a laptop computer, a notebook computer, a netbook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, game devices, display, television, digital television, set top box, wireless access point, base station, node B, subscriber station, mobile subscriber center, radio network controller, router, hub, gateway, bridge, switch, machine, or combination thereof. Accordingly, functions and/or specific configurations of device 900 described herein, may be included or omitted in various embodiments of device 900, as suitably desired.

Embodiments of device 900 may be implemented using single input single output (SISO) architectures. However, certain implementations may include multiple antennas (e.g., antennas 918-f) for transmission and/or reception using adaptive antenna techniques for beamforming or spatial division multiple access (SDMA) and/or using MIMO communication techniques.

The components and features of device 900 may be implemented using any combination of discrete circuitry, application specific integrated circuits (ASICs), logic gates and/or single chip architectures. Further, the features of device 900 may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

It should be appreciated that the exemplary device 900 shown in the block diagram of FIG. 9 may represent one functionally descriptive example of many potential implementations. Accordingly, division, omission or inclusion of block functions depicted in the accompanying figures does not infer that the hardware components, circuits, software and/or elements for implementing these functions would be necessarily be divided, omitted, or included in embodiments.

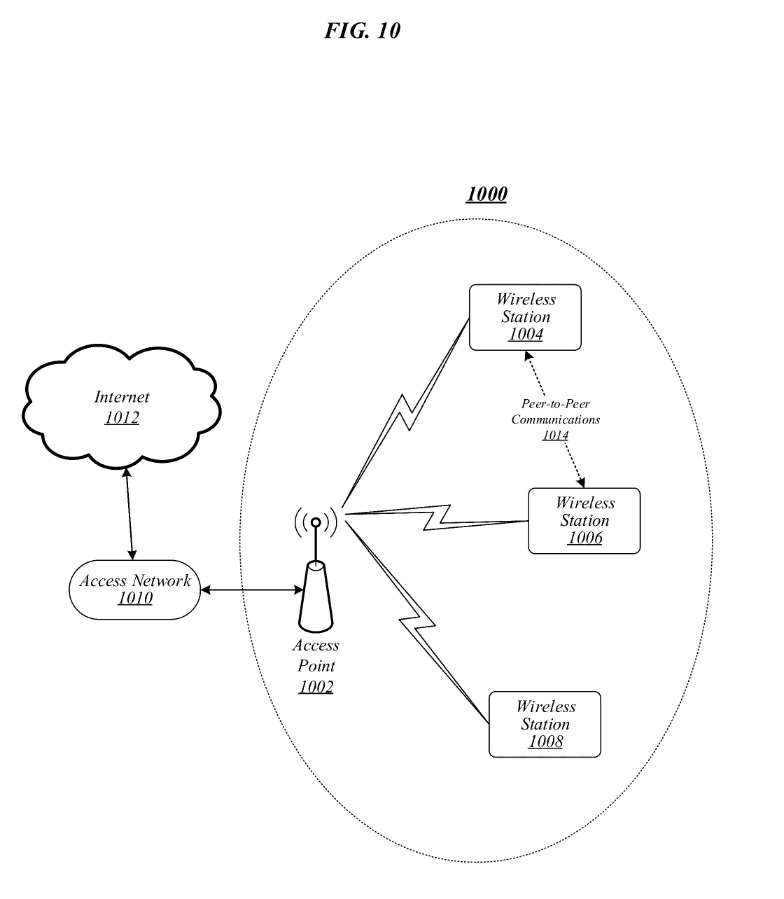

FIG. 10 illustrates an embodiment of a wireless network 1000. As shown in FIG. 10, wireless network comprises an access point 1002 and wireless stations 1004, 1006, and 1008. In various embodiments, wireless network 1000 may comprise a wireless local area network (WLAN), such as a WLAN implementing one or more Institute of Electrical and Electronics Engineers (IEEE) 802.11 standards (sometimes collectively referred to as “Wi-Fi”). In some other embodiments, wireless network 1000 may comprise another type of wireless network, and/or may implement other wireless communications standards. In various embodiments, for example, wireless network 1000 may comprise a WWAN or WPAN rather than a WLAN. The embodiments are not limited to this example.

In some embodiments, wireless network 1000 may implement one or more broadband wireless communications standards, such as 3G or 4G standards, including their revisions, progeny, and variants. Examples of 3G or 4G wireless standards may include without limitation any of the IEEE 802.16m and 802.16p standards, 3rd Generation Partnership Project (3GPP) Long Term Evolution (LTE) and LTE-Advanced (LTE-A) standards, and International Mobile Telecommunications Advanced (IMT-ADV) standards, including their revisions, progeny and variants. Other suitable examples may include, without limitation, Global System for Mobile Communications (GSM)/Enhanced Data Rates for GSM Evolution (EDGE) technologies, Universal Mobile Telecommunications System (UMTS)/High Speed Packet Access (HSPA) technologies, Worldwide Interoperability for Microwave Access (WiMAX) or the WiMAX II technologies, Code Division Multiple Access (CDMA) 2000 system technologies (e.g., CDMA2000 1×RTT, CDMA2000 EV-DO, CDMA EV-DV, and so forth), High Performance Radio Metropolitan Area Network (HIPERMAN) technologies as defined by the European Telecommunications Standards Institute (ETSI) Broadband Radio Access Networks (BRAN), Wireless Broadband (WiBro) technologies, GSM with General Packet Radio Service (GPRS) system (GSM/GPRS) technologies, High Speed Downlink Packet Access (HSDPA) technologies, High Speed Orthogonal Frequency-Division Multiplexing (OFDM) Packet Access (HSOPA) technologies, High-Speed Uplink Packet Access (HSUPA) system technologies, 3GPP Rel. 8-12 of LTE/System Architecture Evolution (SAE), and so forth. The embodiments are not limited in this context.

In various embodiments, wireless stations 1004, 1006, and 1008 may communicate with access point 1002 in order to obtain connectivity to one or more external data networks. In some embodiments, for example, wireless stations 1004, 1006, and 1008 may connect to the Internet 1012 via access point 1002 and access network 1010. In various embodiments, access network 1010 may comprise a private network that provides subscription-based Internet-connectivity, such as an Internet Service Provider (ISP) network. The embodiments are not limited to this example.

In various embodiments, two or more of wireless stations 1004, 1006, and 1008 may communicate with each other directly by exchanging peer-to-peer communications. For example, in the example of FIG. 10, wireless stations 1004 and 1006 communicate with each other directly by exchanging peer-to-peer communications 1014. In some embodiments, such peer-to-peer communications may be performed according to one or more Wi-Fi Alliance (WFA) standards. For example, in various embodiments, such peer-to-peer communications may be performed according to the WFA Wi-Fi Direct standard, 2010 Release. In various embodiments, such peer-to-peer communications may additionally or alternatively be performed using one or more interfaces, protocols, and/or standards developed by the WFA Wi-Fi Direct Services (WFDS) Task Group. The embodiments are not limited to these examples.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor. Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

Example 1 is at least one non-transitory computer-readable storage medium comprising a set of instructions that, in response to being executed on a computing device, cause the computing device to identify a connection request of a mobile client based on a received connection establishment message, determine whether the connection request comprises an automatic connection request based on request attribute information contained in the connection establishment message, and in response to a determination that the connection request comprises an automatic connection request, generate a prompt for a confirmation that the connection request is to be granted.

Example 2 is the at least one non-transitory computer-readable storage medium of Example 1, comprising instructions that, in response to being executed on the computing device, cause the computing device to in response to a determination that the connection request comprises a manual connection request determine whether the mobile client comprises an approved device, in response to a determination that the mobile client comprises an approved device, grant the connection request, and in response to a determination that the mobile client does not comprise an approved device, generate the prompt for the confirmation that the connection request is to be granted.

Example 3 is the at least one non-transitory computer-readable storage medium of Example 1, comprising instructions that, in response to being executed on the computing device, cause the computing device to monitor one or more input devices to determine whether the confirmation has been received, in response to a determination that the confirmation has been received, grant the connection request, and in response to a determination that the confirmation has not been received, reject the connection request.

Example 4 is the at least one non-transitory computer-readable storage medium of Example 1, the connection establishment message to contain an information element (IE) comprising the request attribute information.

Example 5 is the at least one non-transitory computer-readable storage medium of Example 4, the request attribute information to comprise a value in a field of the IE, the value to indicate whether the connection request comprises an automatic connection request or a manual connection request.

Example 6 is the at least one non-transitory computer-readable storage medium of Example 4, the IE to comprise a vendor-specific IE.

Example 7 is the at least one non-transitory computer-readable storage medium of Example 4, the IE to contain an Element Identifier (ID) field comprising a value to indicate a type of the IE.

Example 8 is the at least one non-transitory computer-readable storage medium of Example 7, the Element ID field to comprise a value of 221.

Example 9 is the at least one non-transitory computer-readable storage medium of Example 4, the IE to contain a Length field comprising a value to indicate a length of the IE.

Example 10 is the at least one non-transitory computer-readable storage medium of Example 4, the IE to contain an Organizationally-Unique Identifier (OUI) field comprising a value to identify a defining entity of a protocol for interpreting a Data field of the IE.

Example 11 is the at least one non-transitory computer-readable storage medium of Example 10, the OUI field to comprise a value of 0x001735.

Example 12 is the at least one non-transitory computer-readable storage medium of Example 10, the Data field to comprise the request attribute information.

Example 13 is the at least one non-transitory computer-readable storage medium of Example 1, the connection establishment message to comprise a Wi-Fi Peer-to-Peer (P2P) message.

Example 14 is the at least one non-transitory computer-readable storage medium of Example 1, the connection establishment message to comprise a Provision Discovery Request frame.

Example 15 is the at least one non-transitory computer-readable storage medium of Example 1, the connection establishment message to comprise a Group Owner (GO) Negotiation Request frame.

Example 16 is the at least one non-transitory computer-readable storage medium of Example 1, the connection establishment message to comprise a Peer-to-Peer (P2P) Invitation Request frame.

Example 17 is the at least one non-transitory computer-readable storage medium of Example 1, the connection establishment message to comprise a message defined in an Institute of Electrical and Electronics Engineers (IEEE) 802.11 standard.

Example 18 is the at least one non-transitory computer-readable storage medium of Example 1, the connection establishment message to comprise a message defined in a 3rd Generation Partnership Project (3GPP) standard.

Example 19 is the at least one non-transitory computer-readable storage medium of Example 1, the computing device to comprise an all-in-one (AIO) computing device, the connection request to comprise a request for wireless connectivity to one or more devices via a wireless dock of the AIO computing device.

Example 20 is an apparatus, comprising logic, at least a portion of which is in hardware, the logic to identify a connection request of a mobile client based on a received connection establishment message, determine whether the connection request comprises an automatic connection request based on request attribute information contained in the connection establishment message, and in response to a determination that the connection request comprises an automatic connection request, generate a prompt for a confirmation that the connection request is to be granted.

Example 21 is the apparatus of Example 20, the logic to in response to a determination that the connection request comprises a manual connection request determine whether the mobile client comprises an approved device, in response to a determination that the mobile client comprises an approved device, grant the connection request, and in response to a determination that the mobile client does not comprise an approved device, generate the prompt for the confirmation that the connection request is to be granted.

Example 22 is the apparatus of Example 20, the logic to monitor one or more input devices to determine whether the confirmation has been received, in response to a determination that the confirmation has been received, grant the connection request, and in response to a determination that the confirmation has not been received, reject the connection request.

Example 23 is the apparatus of Example 20, the connection establishment message to contain an information element (IE) comprising the request attribute information.

Example 24 is the apparatus of Example 23, the request attribute information to comprise a value in a field of the IE, the value to indicate whether the connection request comprises an automatic connection request or a manual connection request.

Example 25 is the apparatus of Example 23, the IE to comprise a vendor-specific IE.

Example 26 is the apparatus of Example 23, the IE to contain an Element Identifier (ID) field comprising a value to indicate a type of the IE.

Example 27 is the apparatus of Example 26, the Element ID field to comprise a value of 221.

Example 28 is the apparatus of Example 23, the IE to contain a Length field comprising a value to indicate a length of the IE.

Example 29 is the apparatus of Example 23, the IE to contain an Organizationally-Unique Identifier (OUI) field comprising a value to identify a defining entity of a protocol for interpreting a Data field of the IE.

Example 30 is the apparatus of Example 29, the OUI field to comprise a value of 0x001735.

Example 31 is the apparatus of Example 29, the Data field to comprise the request attribute information.

Example 32 is the apparatus of Example 20, the connection establishment message to comprise a Wi-Fi Peer-to-Peer (P2P) message.

Example 33 is the apparatus of Example 20, the connection establishment message to comprise a Provision Discovery Request frame.

Example 34 is the apparatus of Example 20, the connection establishment message to comprise a Group Owner (GO) Negotiation Request frame.

Example 35 is the apparatus of Example 20, the connection establishment message to comprise a Peer-to-Peer (P2P) Invitation Request frame.

Example 36 is the apparatus of Example 20, the connection establishment message to comprise a message defined in an Institute of Electrical and Electronics Engineers (IEEE) 802.11 standard.

Example 37 is the apparatus of Example 20, the connection establishment message to comprise a message defined in a 3rd Generation Partnership Project (3GPP) standard.

Example 38 is an all-in-one (AIO) computing device comprising the apparatus of Example 20, the connection request to comprise a request for wireless connectivity to one or more devices via a wireless dock of the AIO computing device.

Example 39 is the AIO computing device of Example 38, comprising at least one radio frequency (RF) transceiver, and at least one RF antenna.

Example 40 is a method, comprising identifying, by processing circuitry of a computing device, a connection request of a mobile client based on a received connection establishment message, determining whether the connection request comprises an automatic connection request based on request attribute information contained in the connection establishment message, and in response to a determination that the connection request comprises an automatic connection request, generating a prompt for a confirmation that the connection request is to be granted.

Example 41 is the method of Example 40, comprising in response to a determination that the connection request comprises a manual connection request determining whether the mobile client comprises an approved device, in response to a determination that the mobile client comprises an approved device, granting the connection request, and in response to a determination that the mobile client does not comprise an approved device, generating the prompt for the confirmation that the connection request is to be granted.

Example 42 is the method of Example 40, comprising monitoring one or more input devices to determine whether the confirmation has been received, in response to a determination that the confirmation has been received, granting the connection request, and in response to a determination that the confirmation has not been received, rejecting the connection request.

Example 43 is the method of Example 40, the connection establishment message to contain an information element (IE) comprising the request attribute information.

Example 44 is the method of Example 43, the request attribute information to comprise a value in a field of the IE, the value to indicate whether the connection request comprises an automatic connection request or a manual connection request.

Example 45 is the method of Example 43, the IE to comprise a vendor-specific IE.

Example 46 is the method of Example 43, the IE to contain an Element Identifier (ID) field comprising a value to indicate a type of the IE.

Example 47 is the method of Example 46, the Element ID field to comprise a value of 221.

Example 48 is the method of Example 43, the IE to contain a Length field comprising a value to indicate a length of the IE.

Example 49 is the method of Example 43, the IE to contain an Organizationally-Unique Identifier (OUI) field comprising a value to identify a defining entity of a protocol for interpreting a Data field of the IE.

Example 50 is the method of Example 49, the OUI field to comprise a value of 0x001735.

Example 51 is the method of Example 49, the Data field to comprise the request attribute information.

Example 52 is the method of Example 40, the connection establishment message to comprise a Wi-Fi Peer-to-Peer (P2P) message.

Example 53 is the method of Example 40, the connection establishment message to comprise a Provision Discovery Request frame.

Example 54 is the method of Example 40, the connection establishment message to comprise a Group Owner (GO) Negotiation Request frame.

Example 55 is the method of Example 40, the connection establishment message to comprise a Peer-to-Peer (P2P) Invitation Request frame.

Example 56 is the method of Example 40, the connection establishment message to comprise a message defined in an Institute of Electrical and Electronics Engineers (IEEE) 802.11 standard.

Example 57 is the method of Example 40, the connection establishment message to comprise a message defined in a 3rd Generation Partnership Project (3GPP) standard.

Example 58 is the method of Example 40, the computing device to comprise an all-in-one (AIO) computing device, the connection request to comprise a request for wireless connectivity to one or more devices via a wireless dock of the AIO computing device.

Example 59 is at least one non-transitory computer-readable storage medium comprising a set of instructions that, in response to being executed on a computing device, cause the computing device to perform a method according to any of Examples 40 to 58.

Example 60 is an apparatus, comprising means for performing a method according to any of Examples 40 to 58.

Example 61 is a system, comprising the apparatus of Example 60, at least one radio frequency (RF) transceiver, and at least one RF antenna.

Example 62 is an apparatus, comprising means for identifying a connection request of a mobile client based on a received connection establishment message, means for determining whether the connection request comprises an automatic connection request based on request attribute information contained in the connection establishment message, and means for generating a prompt for a confirmation that the connection request is to be granted in response to a determination that the connection request comprises an automatic connection request.

Example 63 is the apparatus of Example 62, comprising means for, in response to a determination that the connection request comprises a manual connection request determining whether the mobile client comprises an approved device, in response to a determination that the mobile client comprises an approved device, granting the connection request, and in response to a determination that the mobile client does not comprise an approved device, generating the prompt for the confirmation that the connection request is to be granted.

Example 64 is the apparatus of Example 62, comprising means for monitoring one or more input devices to determine whether the confirmation has been received, means for granting the connection request in response to a determination that the confirmation has been received, and means for rejecting the connection request in response to a determination that the confirmation has not been received.

Example 65 is the apparatus of Example 62, the connection establishment message to contain an information element (IE) comprising the request attribute information.

Example 66 is the apparatus of Example 65, the request attribute information to comprise a value in a field of the IE, the value to indicate whether the connection request comprises an automatic connection request or a manual connection request.

Example 67 is the apparatus of Example 65, the IE to comprise a vendor-specific IE.

Example 68 is the apparatus of Example 65, the IE to contain an Element Identifier (ID) field comprising a value to indicate a type of the IE.

Example 69 is the apparatus of Example 68, the Element ID field to comprise a value of 221.

Example 70 is the apparatus of Example 65, the IE to contain a Length field comprising a value to indicate a length of the IE.

Example 71 is the apparatus of Example 65, the IE to contain an Organizationally-Unique Identifier (OUI) field comprising a value to identify a defining entity of a protocol for interpreting a Data field of the IE.

Example 72 is the apparatus of Example 71, the OUI field to comprise a value of 0x001735.

Example 73 is the apparatus of Example 71, the Data field to comprise the request attribute information.

Example 74 is the apparatus of Example 62, the connection establishment message to comprise a Wi-Fi Peer-to-Peer (P2P) message.

Example 75 is the apparatus of Example 62, the connection establishment message to comprise a Provision Discovery Request frame.

Example 76 is the apparatus of Example 62, the connection establishment message to comprise a Group Owner (GO) Negotiation Request frame.

Example 77 is the apparatus of Example 62, the connection establishment message to comprise a Peer-to-Peer (P2P) Invitation Request frame.

Example 78 is the apparatus of Example 62, the connection establishment message to comprise a message defined in an Institute of Electrical and Electronics Engineers (IEEE) 802.11 standard.

Example 79 is the apparatus of Example 62, the connection establishment message to comprise a message defined in a 3rd Generation Partnership Project (3GPP) standard.

Example 80 is an all-in-one (AIO) computing device comprising the apparatus of Example 62, the connection request to comprise a request for wireless connectivity to one or more devices via a wireless dock of the AIO computing device.

Example 81 is the AIO computing device of Example 80, comprising at least one radio frequency (RF) transceiver, and at least one RF antenna.

Numerous specific details have been set forth herein to provide a thorough understanding of the embodiments. It will be understood by those skilled in the art, however, that the embodiments may be practiced without these specific details. In other instances, well-known operations, components, and circuits have not been described in detail so as not to obscure the embodiments. It can be appreciated that the specific structural and functional details disclosed herein may be representative and do not necessarily limit the scope of the embodiments.

Some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

It should be noted that the methods described herein do not have to be executed in the order described, or in any particular order. Moreover, various activities described with respect to the methods identified herein can be executed in serial or parallel fashion.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. It is to be understood that the above description has been made in an illustrative fashion, and not a restrictive one. Combinations of the above embodiments, and other embodiments not specifically described herein will be apparent to those of skill in the art upon reviewing the above description. Thus, the scope of various embodiments includes any other applications in which the above compositions, structures, and methods are used.

It is emphasized that the Abstract of the Disclosure is provided to comply with 37 C.F.R. §1.72 (b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate preferred embodiment. In the appended claims, the terms “including” and “in which” are used as the plain-English equivalents of the respective terms “comprising” and “wherein,” respectively. Moreover, the terms “first,” “second,” and “third,” etc. are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. At least one non-transitory computer-readable storage medium comprising a set of instructions that, in response to being executed on a computing device, cause the computing device to:
identify a connection request of a mobile client based on a received connection establishment message;
determine whether the connection request comprises an automatic connection request based on request attribute information contained in the connection establishment message; and
in response to a determination that the connection request comprises an automatic connection request, generate a prompt for a confirmation that the connection request is to be granted.

2. The at least one non-transitory computer-readable storage medium of claim 1, comprising instructions that, in response to being executed on the computing device, cause the computing device to:
in response to a determination that the connection request comprises a manual connection request:
determine whether the mobile client comprises an approved device;
in response to a determination that the mobile client comprises an approved device, grant the connection request; and
in response to a determination that the mobile client does not comprise an approved device, generate the prompt for the confirmation that the connection request is to be granted.

3. The at least one non-transitory computer-readable storage medium of claim 1, comprising instructions that, in response to being executed on the computing device, cause the computing device to:
monitor one or more input devices to determine whether the confirmation has been received;
in response to a determination that the confirmation has been received, grant the connection request; and
in response to a determination that the confirmation has not been received, reject the connection request.

4. The at least one non-transitory computer-readable storage medium of claim 1, the connection establishment message to contain an information element (IE) comprising the request attribute information.

5. The at least one non-transitory computer-readable storage medium of claim 4, the request attribute information to comprise a value in a field of the IE, the value to indicate whether the connection request comprises an automatic connection request or a manual connection request.

6. The at least one non-transitory computer-readable storage medium of claim 4, the IE to comprise a vendor-specific IE.

7. The at least one non-transitory computer-readable storage medium of claim 1, the connection establishment message to comprise a Provision Discovery Request frame, a Group Owner (GO) Negotiation Request frame, or a Peer-to-Peer (P2P) Invitation Request frame.

8. The at least one non-transitory computer-readable storage medium of claim 1, the computing device to comprise an all-in-one (AIO) computing device, the connection request to comprise a request for wireless connectivity to one or more devices via a wireless dock of the AIO computing device.

9. An apparatus, comprising:
logic, at least a portion of which is in hardware, the logic to identify a connection request of a mobile client based on a received connection establishment message, determine whether the connection request comprises an automatic connection request based on request attribute information contained in the connection establishment message, and in response to a determination that the connection request comprises an automatic connection request, generate a prompt for a confirmation that the connection request is to be granted.

10. The apparatus of claim 9, the logic to:
in response to a determination that the connection request comprises a manual connection request:
determine whether the mobile client comprises an approved device;
in response to a determination that the mobile client comprises an approved device, grant the connection request; and
in response to a determination that the mobile client does not comprise an approved device, generate the prompt for the confirmation that the connection request is to be granted.

11. The apparatus of claim 9, the logic to:
monitor one or more input devices to determine whether the confirmation has been received;
in response to a determination that the confirmation has been received, grant the connection request; and
in response to a determination that the confirmation has not been received, reject the connection request.

12. The apparatus of claim 9, the connection establishment message to contain an information element (IE) comprising the request attribute information.

13. The apparatus of claim 12, the request attribute information to comprise a value in a field of the IE, the value to indicate whether the connection request comprises an automatic connection request or a manual connection request.

14. The apparatus of claim 12, the IE to comprise a vendor-specific IE.

15. The apparatus of claim 9, the connection establishment message to comprise a Provision Discovery Request frame, a Group Owner (GO) Negotiation Request frame, or a Peer-to-Peer (P2P) Invitation Request frame.

16. An all-in-one (AIO) computing device comprising the apparatus of claim 9, the connection request to comprise a request for wireless connectivity to one or more devices via a wireless dock of the AIO computing device.

17. The AIO computing device of claim 16, comprising:
at least one radio frequency (RF) transceiver; and
at least one RF antenna.

18. A method, comprising:
identifying, by processing circuitry of a computing device, a connection request of a mobile client based on a received connection establishment message;
determining whether the connection request comprises an automatic connection request based on request attribute information contained in the connection establishment message; and
in response to a determination that the connection request comprises an automatic connection request, generating a prompt for a confirmation that the connection request is to be granted.

19. The method of claim 18, comprising:
in response to a determination that the connection request comprises a manual connection request:
determining whether the mobile client comprises an approved device;
in response to a determination that the mobile client comprises an approved device, granting the connection request; and
in response to a determination that the mobile client does not comprise an approved device, generating the prompt for the confirmation that the connection request is to be granted.

20. The method of claim 18, comprising:
monitoring one or more input devices to determine whether the confirmation has been received;
in response to a determination that the confirmation has been received, granting the connection request; and
in response to a determination that the confirmation has not been received, rejecting the connection request.

21. The method of claim 18, the connection establishment message to contain an information element (IE) comprising the request attribute information.

22. The method of claim 21, the request attribute information to comprise a value in a field of the IE, the value to indicate whether the connection request comprises an automatic connection request or a manual connection request.

23. The method of claim 21, the IE to comprise a vendor-specific IE.

24. The method of claim 18, the connection establishment message to comprise a Provision Discovery Request frame, a Group Owner (GO) Negotiation Request frame, or a Peer-to-Peer (P2P) Invitation Request frame.

25. The method of claim 18, the computing device to comprise an all-in-one (AIO) computing device, the connection request to comprise a request for wireless connectivity to one or more devices via a wireless dock of the AIO computing device.
